(19) United States
(12) Patent Application Publication
(10) Pub. No.: US 2005/0255742 A1
(43) Pub. Date: Nov. 17, 2005

(54) Clipping clamp for flexible flat cable

(75) Inventor: Hsine-Kuang Shih, Taoyuan (TW)

Correspondence Address: TROXELL LAW OFFICE PLLC, Suite 1404, 5205 Leesburg Pike, Falls Church, VA, 22041, US

(73) Assignee: P-Two Industries Inc.

(21) Appl. No.: 10/890,102

(22) Filed: Jul. 14, 2004

(30) Foreign Application Priority Data
May 12, 2004 (TW) 93113426

(51) Int. Cl. H01R 4/24

(52) U.S. Cl. 439/492

(57) ABSTRACT

A clipping clamp for the flexible flat cable comprises a bracket and a spring clamp. The bracket has upright retaining post for fixing the retaining hole on the spring clamp. The spring clamp has a long bent section at one end and an inward bent hook at other end which is used for easy connecting and disconnecting the flexible flat cable.

### BACKGROUND OF THE INVENTION

1. Field of the Invention

This invention concerns a clipping clamp for easy and fast connecting and disconnecting the flexible flat cable to the modular slot.

2. Description of the Related Art

As shown in FIG. 1, the prior art of terminal type connector has the connection slot 1′ and the flat cable 2′, they are connected via an adaptor 3′ in order to comply with the connection requirement of the flexible flat cable. Particularly terminals on one end of the adaptor 3 must conform to the slot specification of the connection slot 2. The multiple stage connection of the flexible flat cable would no doubt result power attenuation. For LVDS transmission, it is a big loss because the merit of the low power consumption inhered in LVDS is all gone. Additional terminal adapter means additional production cost. Any slight error occurs in the connecting would adversely affect the efficiency and low yield is troublesome problem for the manufacturer.

To solve the weakness of the prior art of the connector, a new design of connector is developed as shown in FIG. 2. The connector 4′ maintains direct inserting of the flexible flat cable into the slot without the adapter and power attenuation, in which several connecting points on the first surface 6′ of the flexible flat cable 5′ connect to the several connecting points on the second surface 7′ of the connector 4′. The connector 4′ satisfies with the inserted interface to receive the signal slot and the connecting points of the flexible flat cable 5′ under the pressure of the signal slot will build up a communication linkage.

But this connection satisfies only easy linkage, never thinking of damage to the connector the forced connecting and disconnecting would render.

### SUMMARY OF THE INVENTION

Based the serious requirement of the clipping clamp, the inventor has worked hard for year to the improvement of clamp connector for the flexible flat cable and final come up with this clipping clamp.

The main object of this invention is to eliminate the design of the multiple stage connection of the flexible flat cable in order to stop the power attenuation. This clipping clamp uses the bracket and the spring clamp to achieve easy and fast connection and disconnection to the flexible flat cable.

### BRIEF DESCRIPTION OF THE DRAWINGS

FIG. 1 shows the prior art of terminal connector.

FIG. 2 shows the disassembled elevation of the flexible flat cable.

FIG. 3 shows the disassembly of the clipping clamp of this invention.

FIG. 4 shows the assembled elevation of the clipping clamp of this invention.

FIG. 5 shows the side view of the clipping clamp of this invention.

FIG. 6 shows the enlarged assembly of the clipping clamp of this invention.

FIG. 7 shows the dynamic action of assembled elevation of the clipping clamp of this invention.

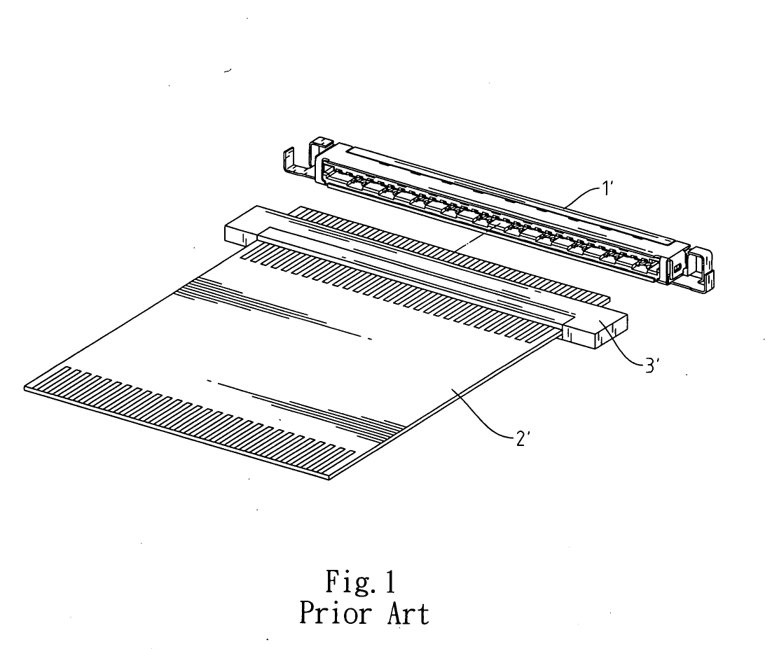

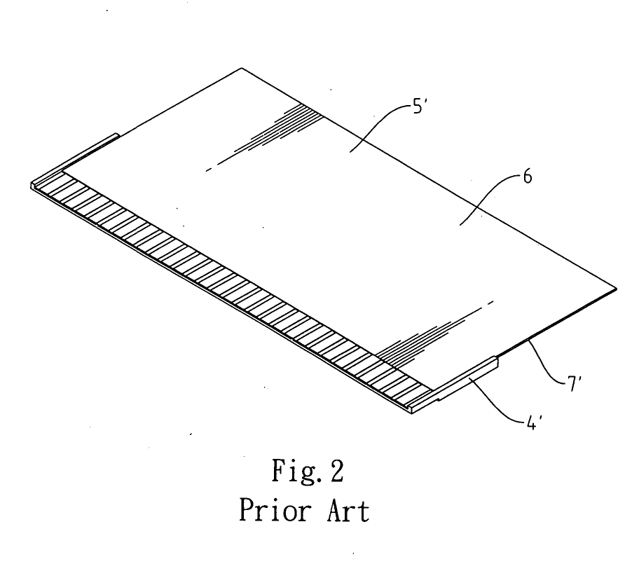

### DETAILED DESCRIPTION OF THE INVENTION

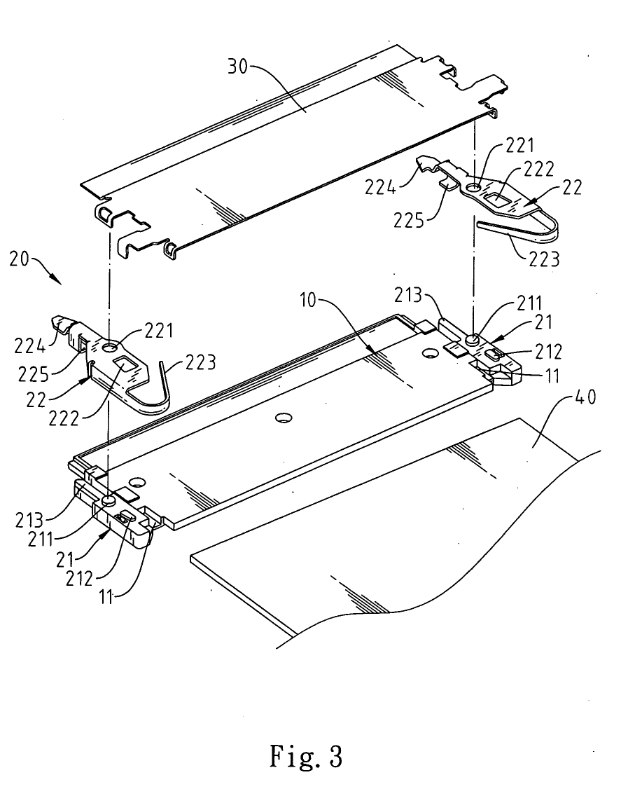

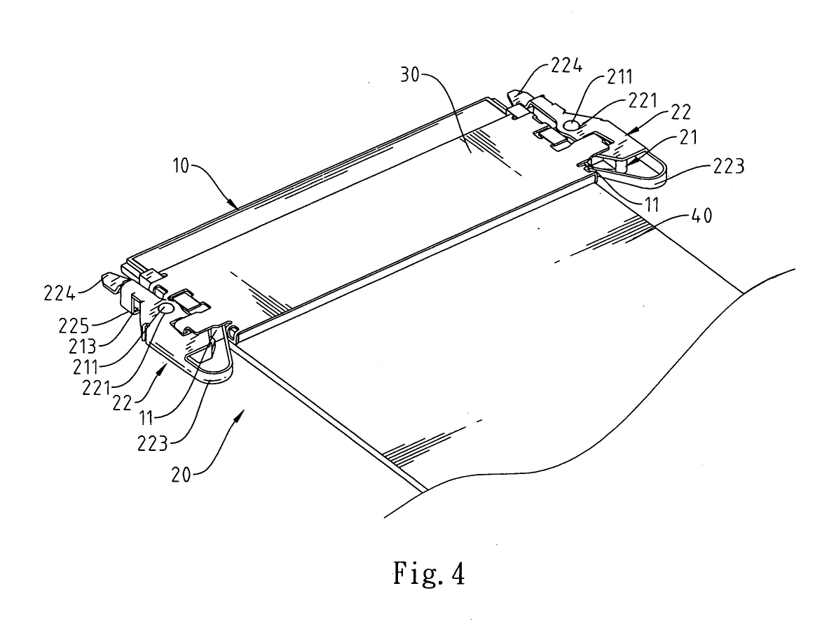

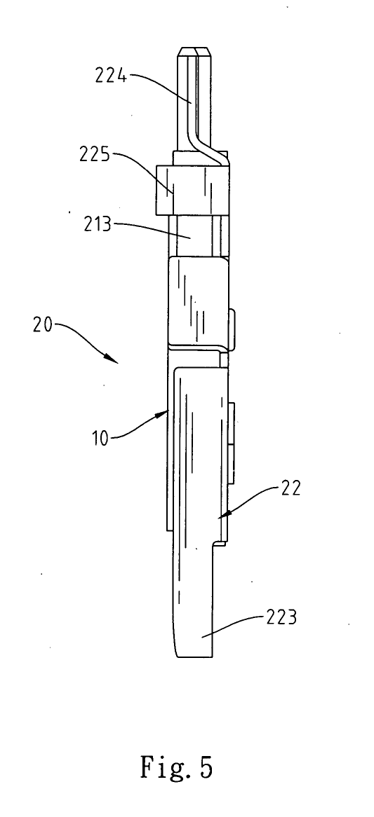

As shown in FIGS. 3 through 7, the clipping clamp of this invention is mounted on both sides of the connector 10 where an insert slot 11 is provided to receive the clipping clamp 20.

The clipping clamp at least comprises:

At least a bracket 21 mounted on both sides of the connector 10. The bracket 21 has an upright retaining post 211, a retaining square 212 at the right side of the retaining post 211 and a guide rod 213 at the left side of the retaining square 212.

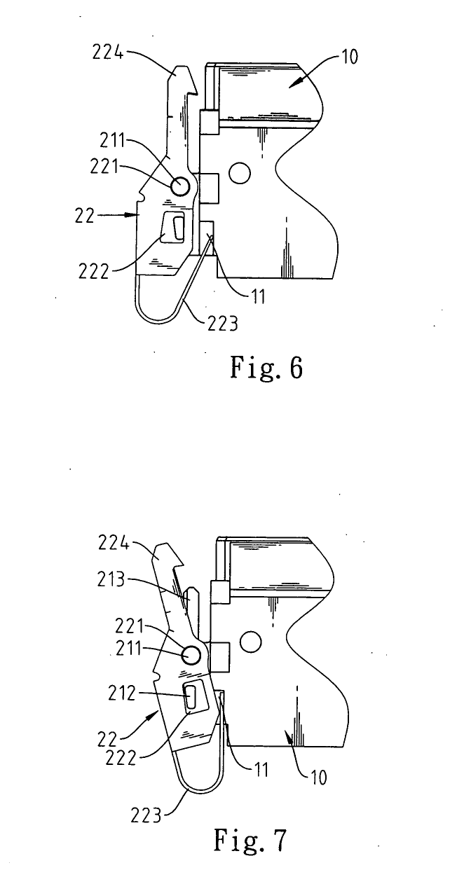

At least a spring clamp 22, a metal part, rides on the top of the bracket 21. Corresponding to the upright post, there is a retaining hole 221 for the retaining post 211 to fits therein and allowing the retaining hole 221 to make angular swing. There is a retaining square slot 222 at the right side of the retaining hole 221 to receive the retaining square 212 where the width of the retaining square slot 222 is greater than that of the retaining square 212 so the spring clamp 22 is free to swing angularly. In other word, the room allowed for the retaining square 212 to move in the retaining square slot 222 is the angular allowance the retaining slot 221 swing along the retaining post 211 as shown in FIGS. 6 and 7. The end spring strip 223 of the spring clamp 22 extends as a tail to be inserted into the insert slot 11 of the connector 10. The other end of the spring clamp 22 forms a hook 224 with one side wall bent to be a guide plate 225 which will attaches to the guide rod 213 of the bracket 21. When the spring clamp 22 swings around the retaining slot 221, the guide plate 225 will lead the guide rod 213 to slide in angle.

As shown in FIGS. 3 through 7, the flat cable 40 is preinstalled on the connector 10. While mounting the clipping clamp 20, the retaining hole 221 fits onto the retaining post 211 and the spring clamp 22 rides on the bracket 21, the guide plate 225 will hold the guide rod 213 of the bracket 21. Finally the spring tail 223 insert into the insert slot 11 to complete the installation of clipping clamp 20. If necessary, reinforcement 30 is added to cover the connector 10 and compress the flat cable 40 and the clipping clamp 20 onto the bracket to prevent them from falling off.

While installing the clipping clamp, use the thumb and the index finger to press the spring clamp 22, the retaining slot 221 and the retaining post 211 will force the hook 224 to expand just like a crab to extend its claws. After insert into the connector 10, release the thumb and the index finger, the spring tail 223 will force the spring clamp 20 to open, turn the retaining hole 221 and the retaining post 211, causing the hook 224 to hook up the signal slot and the spring tail 223 will keep the spring clamp 20 in open so the flat cable 40 and the signal slot are holding together, not easy to get loose.

In case it is necessary to disconnect, hold the spring clamp 22 of the clipping clamp 20 with the thumb and the index finger, turn the retaining hole 221 and the retaining post 211, the hook 224 will widely open like the crab pens its claws, then the clipping clamp 20 is easy to be disconnected.

Viewing from the above statement, it is learned that the multiple stage connection design is discarded, there will never occur power attenuation. The clipping clamp containing the bracket and the spring clamp is a device for easy connecting and disconnecting the flexible flat cable.

1. A clipping clamp mounted on both sides of the connector, mainly comprises:
at least a bracket mounted on the both sides of the connector has an upright retaining post;
at least a spring clamp, riding on the bracket has a retaining slot corresponding to the retaining post; the spring clamp has a long section of spring tail at one end and a hook at other end.

2. The clipping clamp as claimed in claim 1 in which the bracket has an extended guide rod and the spring clamp has a side wall bent to be a guide plate; the guide plate will wrap the guide rod to work as the leading action.

3. The clipping clamp as claimed in claim 1 in which the bracket has a retaining square to fit to the retaining square slot of the spring clamp.

4. The clipping clamp as claimed in claim 1 in which the spring clamp has a long curved spring tail bent backward.

5. The clipping clamp as claimed in claim 1 in which the connector is covered with reinforcement.

6. The clipping clamp as claimed in claim 1 in which the connector has an insert slot to receive the clipping clamp.
